(19) United States
(12) Patent Application Publication
(10) Pub. No.: US 2024/0182368 A1
(43) Pub. Date: Jun. 6, 2024

(54) Powder Compositions Including Chopped Coated Silicon Carbide Fibers and Method of Producing or Repairing a Fiber-Reinforced Ceramic Matrix Composite

(71) Applicants: Rolls-Royce North American Technologies Inc., Indianapolis, IN (US); Rolls-Royce High Temperature Composites Inc., Cypress, CA (US)

(72) Inventors: Robert Hays, Indianapolis, IN (US); Chris Monteleone, Cypress, CA (US); Sujit Nanda, Cypress, CA (US)

(21) Appl. No.: 18/075,758

(22) Filed: Dec. 6, 2022

(51) Int. Cl. C04B 35/80; C04B 35/628; C04B 35/64; C04B 35/657; C04B 41/00; C04B 41/45; C04B 41/50; C04B 41/87

(52) U.S. Cl. CPC C04B 35/80; C04B 35/62863; C04B 35/62892; C04B 35/64; C04B 35/657; C04B 41/009; C04B 41/4539; C04B 41/4572; C04B 41/4596; C04B 41/5059; C04B 41/87; C04B 2235/3826; C04B 2235/428; C04B 2235/5244; C04B 2235/5252; C04B 2235/526; C04B 2235/616

(57) ABSTRACT

A method of producing or repairing a fiber-reinforced ceramic matrix composite comprises delivering a powder composition comprising SiC particles and chopped coated SiC fibers into or onto a powder receptacle configured for composite fabrication or repair. After delivering the powder composition into or onto the powder receptacle, the SiC particles are densified to form a SiC matrix reinforced with the chopped coated SiC fibers, thereby producing or repairing a fiber-reinforced ceramic matrix composite.

### TECHNICAL FIELD

This disclosure relates generally to ceramic matrix composites and more particularly to a method of producing or repairing a fiber-reinforced ceramic matrix composite.

### BACKGROUND

Gas turbine engines include a compressor, combustor and turbine in flow series along a common shaft. Compressed air from the compressor is mixed with fuel in the combustor to generate hot combustion gases that rotate the turbine blades and drive the compressor. Improvements in the thrust and efficiency of gas turbine engines are linked to increasing turbine entry temperatures, which places a heavy burden on turbine engine components. Ceramic matrix composites (CMCs), which include continuous ceramic fibers embedded in a ceramic matrix, exhibit a combination of properties that make them promising candidates for gas turbine engine components and other industrial applications that demand excellent thermal and mechanical properties along with low weight. A ceramic matrix composite that includes a silicon carbide (SiC) matrix reinforced with continuous SiC fibers may be referred to as a fiber-reinforced ceramic matrix composite, or more particularly as a SiC/SiC composite.

### BRIEF DESCRIPTION OF THE DRAWINGS

The embodiments may be better understood with reference to the following drawings and description.

FIG. 1 is a schematic of a powder composition comprising SiC particles and chopped coated SiC fibers.

FIG. 2 is a schematic of a continuous SiC fiber (top) and a coated continuous SiC fiber (bottom).

FIG. 3 is a schematic of chopped coated SiC fibers formed from the coated continuous SiC fiber of FIG. 2.

FIG. 4 is a flow chart representing a method of producing or repairing a fiber-reinforced ceramic matrix composite.

FIGS. 5A-5C are schematics showing delivery of the powder composition of FIG. 5A into a fiber preform (FIG. 5B), followed by densification (FIG. 5C).

FIGS. 6A-6C are schematics showing delivery of the powder composition of FIG. 6A into a mold (FIG. 6B), followed by densification (FIG. 6C).

FIGS. 7A-7C are schematics showing delivery of the powder composition of FIG. 7A into a repair region of a composite (FIG. 7B), followed by densification (FIG. 7C).

FIGS. 8A-8C are schematics showing delivery of the powder composition of FIG. 8A onto a substrate in an additive fabrication process (FIG. 8B), followed by densification (FIG. 8C).

### DETAILED DESCRIPTION

Described herein are novel powder and slurry compositions and a method of producing or repairing a fiber-reinforced ceramic matrix composite utilizing such compositions. The fiber-reinforced ceramic matrix composite may form part or all of a component of a gas turbine engine, such as a blade, vane, combustor liner or seal segment.

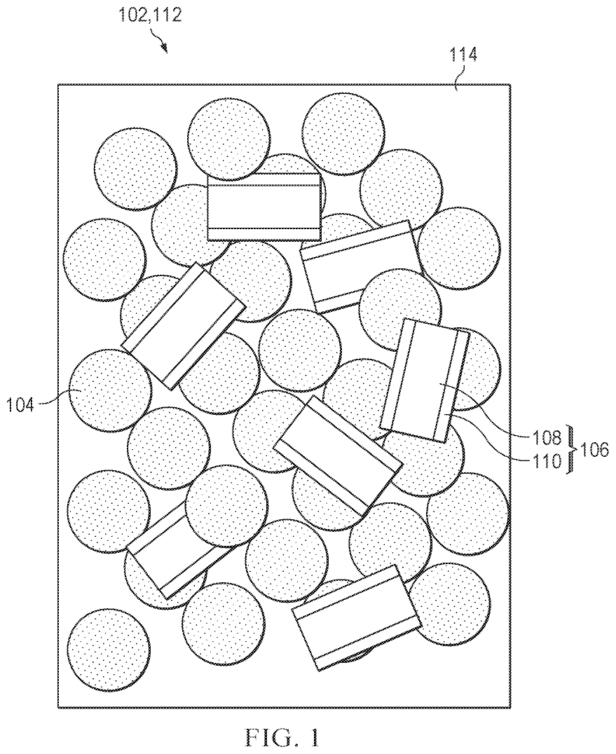

Referring to FIG. 1, the powder composition 102 comprises silicon carbide (SiC) particles 104 and chopped coated SiC fibers 106, that is, chopped SiC fibers 108 having a surface coating 110. For use in making or repairing a composite, the powder composition may comprise a mixture (preferably a homogeneous mixture) of the SiC particles 104 and the chopped coated SiC fibers 106. Such a mixture may be formed by manual mixing or sonication of the powder composition 102.

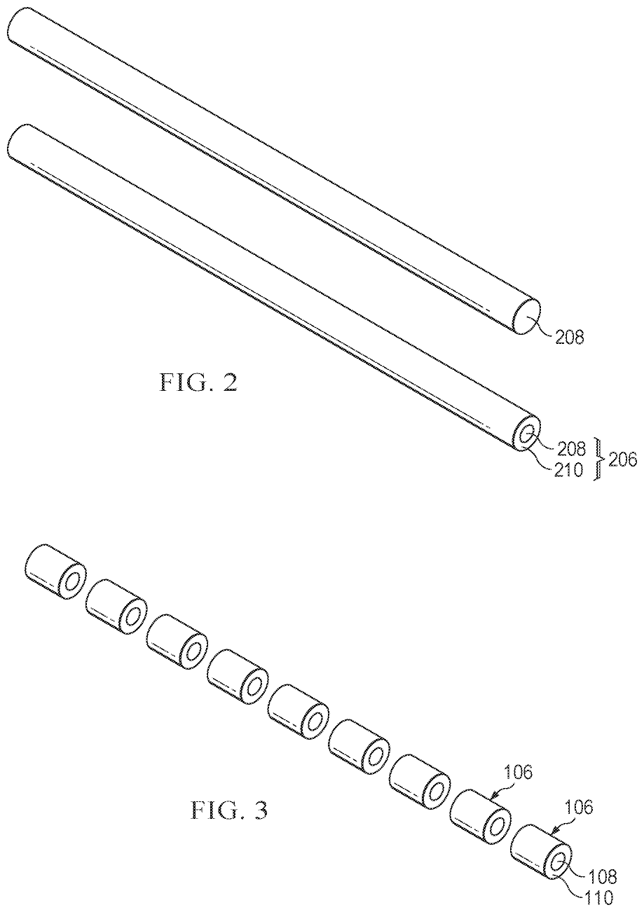

Importantly, the chopped coated SiC fibers 106 may be produced from continuous SiC fibers 208 that include an interface or interphase coating 210. Such coated continuous SiC fibers 206, as shown in FIG. 2, are widely used as reinforcements in ceramic matrix composites. Excess or scrap coated continuous SiC fibers 206 not utilized in ceramic matrix composite production may be chopped up, as illustrated in FIG. 3, to form the chopped coated SiC fibers 106. The chopping may be carried out with a diamond blade or wire, for example, or by laser or water jet machining, shearing, tumbling, or pulverization via volume grinding. In some examples, the chopped coated SiC fibers 106 may be produced from other sources of coated continuous SiC fibers 206. Typically, the interface or interphase coating 210 on the continuous SiC fibers 206, and thus the surface coating 110 on the chopped coated SiC fibers 106, comprises boron nitride, silicon-doped boron nitride, and/or pyrolytic carbon. Generally speaking, carbide, nitride, oxide and/or carbon coatings may be suitable for the interface and surface coatings 210,110. Because the coating 210 is applied to the fibers 206 prior to chopping, ends of each chopped coated SiC fiber 106 may be uncoated, as illustrated in FIG. 3. That is, the surface coating 110 may be present only on the cylindrical portion of the fibers 108 extending between the ends.

The chopped coated SiC fibers 106 may account for from 1 vol. % to 99 vol. %, e.g., at least 1 vol. %, at least 20 vol. %, or at least 40 vol. %, and/or up to 99 vol. %, up to 75 vol. %, or up to 50 vol. %, of the powder composition 102. In some examples, the powder composition 102 may further include a small amount of silicon particles. For example, the powder composition 102 may include the silicon particles at a concentration from 1 vol. % to 10 vol. %. Also or alternatively, the powder composition 102 may include other particulate additives, such as carbon particles. The SiC particles 104 may account for the balance, e.g., from 1 vol. % to 99 vol. % of the powder composition 102. More specifically, the SiC particles 104 may account for at least 1 vol. %, at least 40 vol. %, or at least 60 vol. %, and/or up to 99 vol. %, up to 80 vol. %, up to 50 vol. %, or up to 30 vol. % of the powder composition 102.

The chopped coated SiC fibers 106 may have a nominal length in a range from about 1 micron to about 100 microns, and more typically from about 10 microns to about 30 microns. Preferably, for some applications, the chopped coated SiC fibers 106 may have a length comparable to a linear dimension (e.g., diameter or width) of the SiC particles 104. Generally speaking, the SiC particles 104 may have a linear dimension in a range from about 1 micron to about 100 microns, and more typically from about 10 microns to about 30 microns. Also or alternatively, the chopped coated SiC fibers 106 may have a length comparable to the pore size (e.g., the spacing between adjacent fiber tows) of a fiber preform comprising continuous SiC fibers, since in some examples the chopped coated SiC fibers 106 may be used for slurry infiltration of such fiber preforms, as described below.

The surface coating 110 may have a thickness determined by the coating method used to form the interface or interphase coating 210 on the continuous SiC fibers 208. Normally, the coating method is chemical vapor deposition (CVD) or chemical vapor infiltration (CVI), which may entail delivering gaseous reactants into a heated process chamber that contains the continuous SiC fibers, followed by chemical reactions which lead to deposition of the desired coating. In one example, the gaseous reactants may comprise BX₃ and NH₃, where X is selected from the group consisting of F and CI, to produce a coating comprising boron nitride (BN). In another example, the gaseous reactants may comprise boron trichloride (BCl₃), ammonia (NH₃) and a silicon precursor such as dichlorosilane (H₂Cl₂Si), trichlorosilane (HCl₃Si), silicon tetrachloride (SiCl₄), and/or silane (SiH₄) to produce a coating comprising silicon-doped boron nitride. In yet another example, the gaseous reactants may comprise methane (CH₄), propane (C₃H₈), and/or propylene (C₃H₆) to produce a coating comprising pyrolytic carbon. In the process chamber, the gaseous reactants diffuse through interstices between fibers or fiber tows, and reaction products deposit on exposed surfaces of the fibers, such that the interface or interphase coating is formed. CVD or CVI may lead to conformal coatings of uniform thickness in the nano- to microscale range. Consequently, the surface coating 110 on the chopped coated SiC fibers 106 typically has a uniform thickness in a range from about 0.1 micron (100 nm) to about 1 micron.

The powder composition 102 as described in this disclosure may be dispersed in a liquid 114 to form a slurry 112, as indicated in FIG. 1. The liquid 114 may include water and/or may be an aqueous solution. It is also contemplated that the liquid 114 may comprise an organic solvent. The chopped coated SiC fibers 106 may account for from 1 vol. % to 99 vol. % of the solids content of the slurry. For example, the chopped coated SiC fibers 106 may account for at least 1 vol. %, at least 20 vol. %, or at least 40 vol. %, and/or up to 99 vol. %, up to 75 vol. %, or up to 50 vol. % of the solids content of the slurry. The SiC particles 104 and any other solid-phase constituents, e.g., the silicon particles or carbon particles mentioned above, and/or any other slurry additives, such as a dispersant or surfactant, may account for the remainder of the solids content. In particular, the SiC particles 104 may account for over 50 vol. % of the solids content of the slurry 112. Silicon particles may be present at a concentration from about 1 vol. % to about 10 vol. %, and carbon particles may be present at a concentration from about 1 vol. % to about 10 vol. %. Any other slurry additives may be included individually at a concentration up to about 5 vol. %.

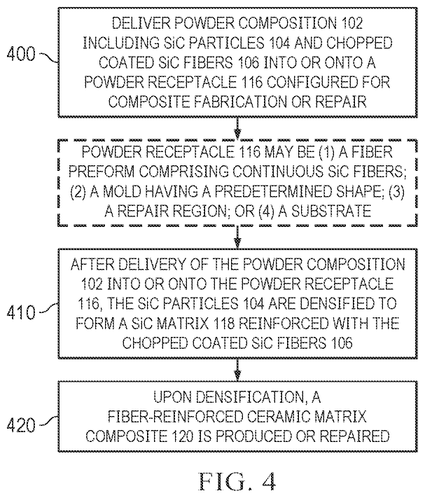

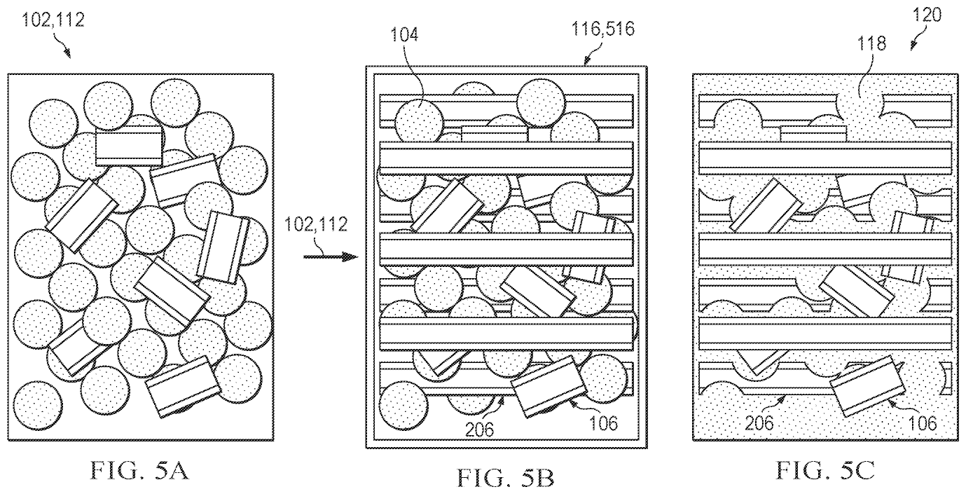

The powder composition 102 and/or slurry 112 described above may be used to produce or repair a composite according to the method represented in the flow chart of FIG. 4, which is illustrated according to various examples in FIGS. 5A-8C. The method may include delivering 400 the powder composition 102, which includes the SiC particles 104 and the chopped coated SiC fibers 106 described above, into or onto a powder receptacle 116 which is configured for fabrication or repair of a fiber-reinforced ceramic matrix composite. The powder receptacle 116 may comprise: (1) a fiber preform including continuous silicon carbide fibers; (2) a mold having a predetermined shape; (3) a repair region of the fiber-reinforced ceramic matrix composite; or (4) a substrate. In some examples, to promote flowability and ease of delivery, a slurry 112 containing the powder composition 102 (where the SiC particles 104 and the chopped coated SiC fibers 106 are dispersed in a liquid 114) may be delivered into or onto the powder receptacle 116. As will be discussed in more detail below, delivery of the powder composition 102 into or onto the powder receptacle 116 may entail slurry infiltration, pouring or conveying, or additive fabrication (e.g., layer-by-layer processing), depending at least in part on whether the powder receptacle 116 takes the form of a fiber preform, a mold, a repair region, or a substrate.

Returning again to FIG. 4, after delivery 400 of the powder composition 102 into or onto the powder receptacle 116, the SiC particles 104 undergo densification 410 to form—either from the fiber preform, within the mold, within the repair region, or on the substrate—a SiC matrix 118 reinforced with the chopped coated SiC fibers 106. Accordingly, upon densification of the SiC particles 104, a fiber-reinforced ceramic matrix composite 120 is fabricated or repaired 420. In examples where the powder receptacle 116 is a fiber preform comprising continuous SiC fibers 208 (e.g., coated continuous SiC fibers 206, as shown in FIG. 2) the SiC matrix 118 formed upon densification is reinforced with both the chopped coated SiC fibers 106 and the coated continuous SiC fibers 206. As discussed in more detail below, densification may be effected by melt infiltration, polymer infiltration and pyrolysis, chemical vapor deposition or infiltration, or sintering/melting. When a slurry 112 is employed for delivery of the powder composition 102 into or onto the powder receptacle 116, some or all of the liquid 114 may be removed from the slurry 112 prior to or during densification. The SiC matrix 118 formed by densification of the SiC particles 104 may be understood to have a residual porosity level of no greater than about 10 vol. %.

Referring now to FIGS. 5A and 5B, when the powder receptacle 116 comprises a fiber preform 516, delivery of the powder composition 102 may entail infiltrating a slurry 112 comprising the powder composition 102 into the fiber preform 516, a process known as slurry infiltration. The fiber preform may be produced by laying up plies comprising the continuous SiC fibers to have a shape of a desired composite component. To effect slurry infiltration of the fiber preform 516, a vacuum may be applied to the fiber preform 516 prior to exposure to the slurry and then removed during infiltration to create a pressure gradient (e.g., about 1 atm) that may enhance capillary forces. The fiber preform 516 may be exposed to the slurry at room temperature (e.g., from about 15° ° C. to about 25° C.). After exposure to the slurry and infiltration, the fiber preform 516 may be dried to remove some or all of the liquid. Drying may be carried out at room temperature or at an elevated temperature (e.g., from about 40° ° C. to about 150° C.). After infiltration with the slurry 112, the SiC particles 104 may be densified to form a SiC matrix 118 reinforced with the chopped coated SiC fibers 106, as illustrated in FIG. 5C, using an approach described below.

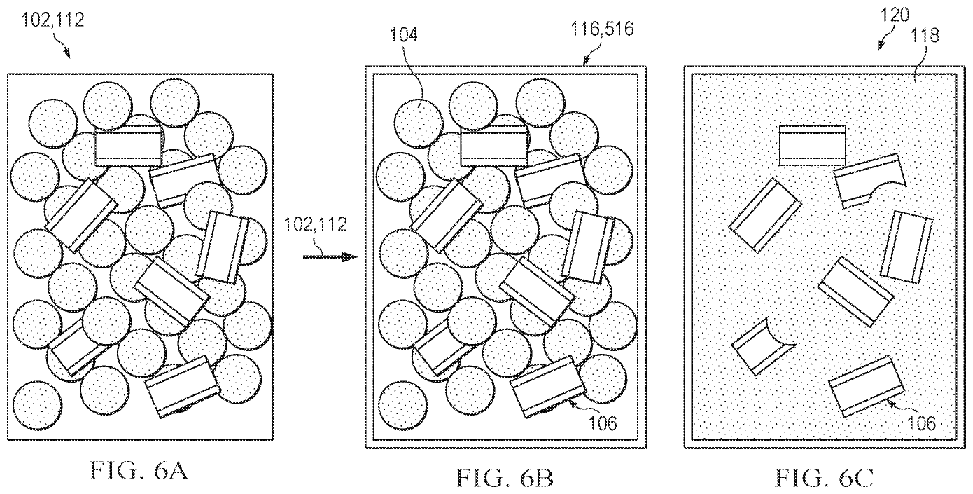

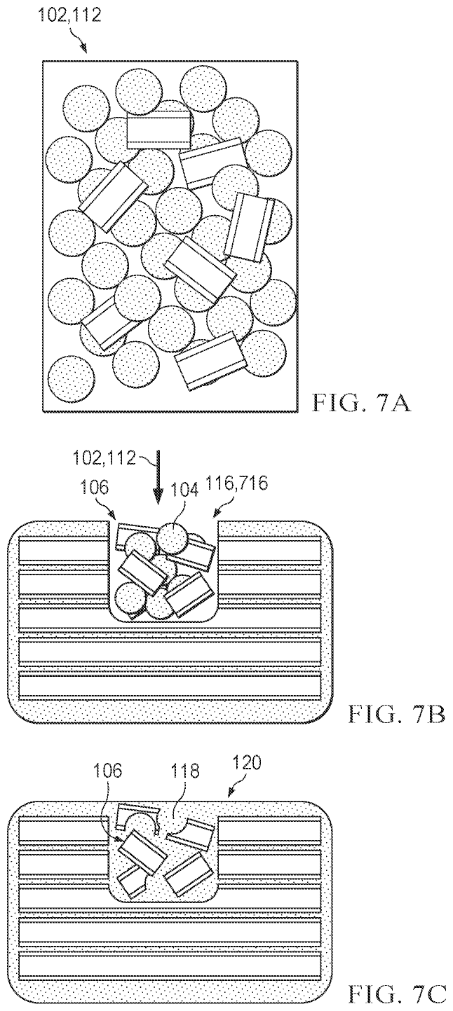

Referring now to FIGS. 6A-6C and 7A-7C, when the powder receptacle 116 comprises either a mold 616 having a predetermined shape or a repair region 716 of the composite, delivery of the powder composition 102 may comprise pouring or conveying a slurry 112 including the powder composition 102 into the mold 616 (FIGS. 6A-6B) or the repair region 716 (FIGS. 7A-7B). Alternatively, the powder composition 102 may be poured or conveyed into the mold 616 or repair region 716 in the form of a dry powder mixture. It is noted that the predetermined shape of the mold may be an inverse of the desired shape of the composite to be produced. In addition, the repair region 716 may include a damaged region of a composite that is optionally further machined to produce the repair region 716 in a size and shape configured to receive the powder composition 102. After delivery of the powder composition 102 into the mold 616 or repair region 716, the SiC particles 104 may be densified to form a SiC matrix 118 reinforced with the chopped coated SiC fibers 106, as illustrated in FIGS. 6C and 7C, using one of the approaches described below.

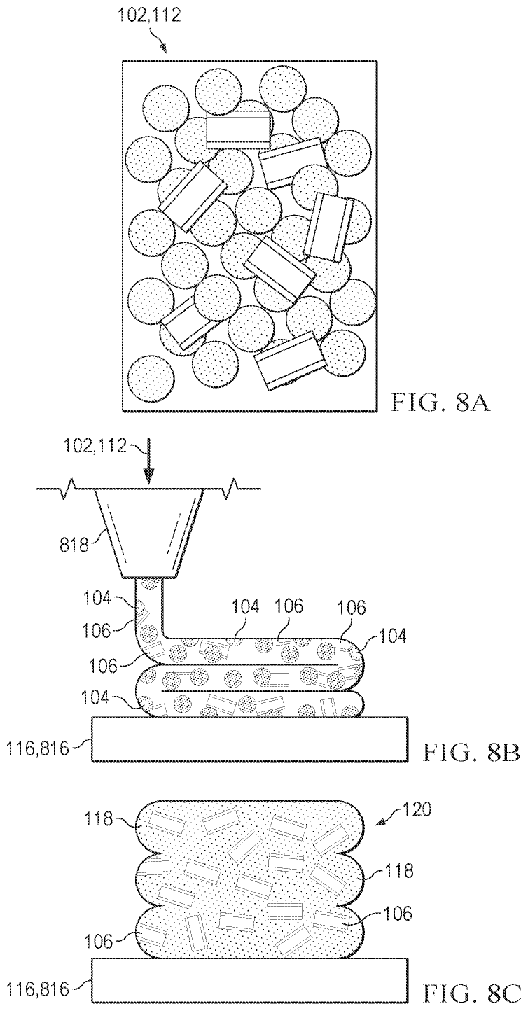

Referring now to FIGS. 8A-8C, when the powder receptacle 116 comprises a substrate 816, delivery of the powder composition 102 may entail depositing a slurry 112 comprising the powder composition 102 on the substrate 816 in an additive, e.g., layer-by-layer, process. For example, the slurry 112 may be extruded through a nozzle 818 moving relative to the substrate 816 to deposit the powder composition 102 in a desired 2D or 3D pattern on the substrate 816, as illustrated in FIG. 8B. After deposition of the powder composition 102 onto the substrate 816, partial or complete drying may optionally be carried out to remove some or all of the liquid, and the SiC particles 104 may be densified to form a SiC matrix 118 reinforced with the chopped coated SiC fibers 106, as illustrated in FIG. 8C, using one of the densification approaches described below.

The densification of the SiC particles 104 that occurs after delivery of the powder composition into or onto the powder receptacle 116 may entail, in one example, infiltrating the powder receptacle 116 with a melt comprising silicon, and then the cooling the melt. In some examples, the melt may comprise pure silicon (“silicon metal,” that is, silicon with only incidental impurities) or a silicon alloy. Alloying elements that may be added to the melt may include carbon, boron, and/or transition metal elements. During melt infiltration, the melt flows through the powder receptacle (e.g, a fiber preform or mold) and reacts with any reactive elements, such as carbon particles, in the flow path. Typically, melt infiltration is carried out at a temperature at or near the melting temperature Tₘ of silicon (1414° C.), which may be from about 1410° C. to about 1500° C., depending on the composition of the melt. Melt infiltration may be carried out for a time duration from several minutes up to several hours, depending on the size and complexity of the powder receptacle 116. Upon cooling of the melt, the SiC particles 104 in or on the powder receptacle 116 are densified and a SiC matrix 118 reinforced with the chopped coated SiC fibers 106 is formed. If the powder receptacle 116 is a fiber preform 516, as illustrated in FIG. 5B, the SiC matrix 118 is also reinforced with the coated continuous SiC fibers 206 from the preform 516. Accordingly, a fiber-reinforced ceramic matrix composite 120 may be produced or repaired.

In a second example, to effect densification after delivery of the powder composition 102 into or onto the powder receptacle 116, polymer infiltration and pyrolysis may be employed. In this example, the powder receptacle 116 may be infiltrated with a formulation comprising a silicon-based polymer, and the formulation may be pyrolyzed to convert the silicon-based polymer to silicon carbide. The silicon-based polymer may thus be understood to function as a silicon carbide ceramic precursor. Examples of suitable silicon-based polymers may include polysilane, polycarbosilane, polysiloxane, and/or polysilazane. To pyrolyze the silicon-based polymer formulation, the powder receptacle 116 may be heated to a temperature in a range from about 850° C. to about 1300° C., causing the silicon-based polymer to be converted to silicon carbide. Typically, pyrolysis is conducted in an inert gas and/or a vacuum environment, such as in a vacuum chamber that has been evacuated and backfilled with a desired pressure of inert gas (e.g., argon, helium and/or nitrogen). As a consequence of pyrolysis, the SiC particles 104 in or on the powder receptacle 116 may be densified and a SiC matrix 118 reinforced with the chopped coated SiC fibers 106 may be formed. Accordingly, a fiber-reinforced ceramic matrix composite 120 may be fabricated or repaired.

In a third example, to effect densification after delivery of the powder composition 102 into or onto the powder receptacle 116, the powder receptacle 116 may be infiltrated with silicon- and carbon-containing gaseous reactant(s), and a solid-phase reaction product comprising SiC may be deposited within or on the powder receptacle 116. Such an approach is typically referred to as chemical vapor deposition (CVD) or chemical vapor infiltration (CVI), and may be carried out as discussed above using, for example, methyltrichlorosilane (CH₃SiCl₃) and H₂ as the silicon-containing gaseous reactants. The amount of SiC deposited may depend on the time duration of gaseous infiltration and reaction product deposition. Due to the deposition of silicon carbide, the SiC particles 104 in or on the powder receptacle 116 may be densified and a SiC matrix 118 reinforced with the chopped coated SiC fibers 106 may be formed. Accordingly, a fiber-reinforced ceramic matrix composite 120 may be produced or repaired.

In a fourth example, to effect densification after delivery of the powder composition 102, heat and optionally pressure may be applied to induce sintering of the SiC particles 104 in or on the powder receptacle 116. Typical sintering temperatures are in a range from about 1800° C. to about 2200° C., and optional pressures may lie in a range from about 10 MPa to about 100 MPa. For powder compositions 102 that include silicon particles and optionally carbon particles, the temperature at which the SiC particles 104 undergo sintering may induce melting of the silicon particles, which may react with the carbon particles and produce additional SiC. Due to the sintering/melting, the SiC particles 104 in or on the powder receptacle 116 may be densified and a SiC matrix 118 reinforced with the chopped coated SiC fibers 106 may be formed. Accordingly, a fiber-reinforced ceramic matrix composite 120 may be produced or repaired.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:

A first aspect relates to a powder composition comprising: SiC particles; and chopped coated SiC fibers comprising chopped SiC fibers with a surface coating thereon.

A second aspect relates to the powder composition of the first aspect, further comprising silicon particles.

A third aspect relates to the powder composition of the first or the second aspect, wherein the surface coating comprises a carbide, a nitride, an oxide, and/or pyrolytic carbon.

A fourth aspect relates to the powder composition of any preceding aspect, wherein ends of each chopped coated SiC fiber are uncoated with the surface coating.

A fifth aspect relates to the powder composition of any preceding aspect, wherein the chopped coated SiC fibers are included at a concentration from 1 vol. % to 99 vol. %.

A sixth aspect relates to the powder composition of any preceding aspect, wherein the chopped coated SiC fibers have a nominal length in a range from about 1 micron to about 100 microns.

A seventh aspect relates to a slurry comprising the powder composition of any preceding claim dispersed in a slurry.

An eighth aspect relates to a method of producing or repairing a fiber-reinforced ceramic matrix composite, the method comprising: delivering a powder composition comprising SiC particles and chopped coated SiC fibers into or onto a powder receptacle configured for composite fabrication or repair; after delivering the powder composition into or onto the powder receptacle, densifying the SiC particles to form a SiC matrix reinforced with the chopped coated SiC fibers, thereby producing or repairing a fiber-reinforced ceramic matrix composite.

A ninth aspect relates to the method of the preceding aspect, wherein the powder receptacle comprises: a fiber preform including continuous SiC fibers; a mold having a predetermined shape; a repair region of the fiber-reinforced ceramic matrix composite; or a substrate.

A tenth aspect relates to the method of any preceding aspect, wherein the powder composition further comprises silicon particles.

An eleventh aspect relates to the method of any preceding aspect, wherein a slurry comprising the powder composition dispersed in a liquid is delivered into or onto the powder receptacle.

A twelfth aspect relates the method of any preceding aspect, wherein the delivering the powder composition into or onto the powder receptacle comprises: slurry infiltration; pouring or conveying; or additive processing.

A thirteenth aspect relates to the method of any of the ninth through the twelfth aspects, wherein the powder receptacle comprises the fiber preform, and wherein delivering the powder composition comprises infiltrating a slurry comprising the powder composition into the fiber preform.

A fourteenth aspect relates to the method of any of the ninth through the thirteenth aspects, wherein the powder receptacle comprises the mold or the repair region, and wherein delivering the powder composition comprises pouring or conveying the powder composition, or pouring or conveying a slurry comprising the powder composition, into the mold or the repair region.

A fifteenth aspect relates to the method of any of the ninth through the fourteenth aspects, wherein delivering the powder composition comprises depositing a slurry comprising the powder composition onto the substrate in a layer-by-layer process.

A sixteenth aspect relates to the method of any preceding aspect, wherein densifying the SiC particles comprises: infiltrating the powder receptacle with a melt comprising silicon, and cooling the melt.

A seventeenth aspect relates to the method of any preceding aspect, wherein densifying the SiC particles comprises: infiltrating the powder receptacle with a formulation comprising a silicon-based polymer, and pyrolyzing the formulation to convert the silicon-based polymer to silicon carbide.

An eighteenth aspect relates to the method any preceding aspect, wherein densifying the silicon carbide particles comprises: infiltrating the powder receptacle with silicon- and carbon-containing gaseous reactant(s); and depositing a solid-phase reaction product comprising SiC within and/or on the powder receptacle.

A nineteenth aspect relates the method of any preceding aspect, wherein densifying the SiC particles comprises: heating the powder receptacle to induce sintering of the SiC particles.

A twentieth aspect relates to the method of any preceding aspect, wherein the powder composition further comprises silicon particles, and wherein the heating induces melting of the silicon particles.

In addition to the features mentioned in each of the independent aspects enumerated above, some examples may show, alone or in combination, the optional features mentioned in the dependent aspects and/or as disclosed in the description above and shown in the figures.

What is claimed is:

1. A powder composition comprising:
SiC particles; and
chopped coated SiC fibers comprising chopped SiC fibers with a surface coating thereon.

2. The powder composition of claim 1, further comprising silicon particles.

3. The powder composition of claim 1, wherein the surface coating comprises a carbide, a nitride, an oxide, and/or pyrolytic carbon.

4. The powder composition of claim 1, wherein ends of each chopped coated SiC fiber are uncoated with the surface coating.

5. The powder composition of claim 1 comprising the chopped coated SiC fibers at a concentration from 1 vol. % to 99 vol. %.

6. The powder composition of claim 1, wherein the chopped coated SiC fibers have a nominal length in a range from about 1 micron to about 100 microns.

7. A slurry comprising:
the powder composition of claim 1 dispersed in a liquid.

8. A method of producing or repairing a fiber-reinforced ceramic matrix composite, the method comprising:
delivering a powder composition comprising SiC particles and chopped coated SiC fibers into or onto a powder receptacle configured for composite fabrication or repair;
after delivering the powder composition into or onto the powder receptacle, densifying the SiC particles to form a SiC matrix reinforced with the chopped coated SiC fibers, thereby producing or repairing a fiber-reinforced ceramic matrix composite.

9. The method of claim 8, wherein the powder receptacle comprises:
a fiber preform including continuous SiC fibers;
a mold having a predetermined shape;
a repair region of the fiber-reinforced ceramic matrix composite; or
a substrate.

10. The method of claim 8, wherein the powder composition further comprises silicon particles.

11. The method of claim 8, wherein a slurry comprising the powder composition dispersed in a liquid is delivered into or onto the powder receptacle.

12. The method of claim 8, wherein the delivering the powder composition into or onto the powder receptacle comprises: slurry infiltration;
pouring or conveying; or additive processing.

13. The method of claim 9, wherein the powder receptacle comprises the fiber preform, and
wherein delivering the powder composition comprises infiltrating a slurry comprising the powder composition into the fiber preform.

14. The method of claim 9, wherein the powder receptacle comprises the mold or the repair region, and
wherein delivering the powder composition comprises pouring or conveying the powder composition, or pouring or conveying a slurry comprising the powder composition, into the mold or the repair region.

15. The method of claim 9, wherein the powder receptacle comprises the substrate, and
wherein delivering the powder composition comprises depositing a slurry comprising the powder composition onto the substrate in a layer-by-layer process.

16. The method of claim 8, wherein densifying the SiC particles comprises:
infiltrating the powder receptacle with a melt comprising silicon, and cooling the melt.

17. The method of claim 8, wherein densifying the SiC particles comprises:
infiltrating the powder receptacle with a formulation comprising a silicon-based polymer, and
pyrolyzing the formulation to convert the silicon-based polymer to SiC.

18. The method of claim 8, wherein densifying the SiC particles comprises:
infiltrating the powder receptacle with silicon- and carbon-containing gaseous reactant(s); and
depositing a solid-phase reaction product comprising SiC within and/or on the powder receptacle.

19. The method of claim 8, wherein densifying the SiC particles comprises:
heating the powder receptacle to induce sintering of the SiC particles.

20. The method of claim 19, wherein the powder composition further comprises silicon particles, and
wherein the heating induces melting of the silicon particles.
